(19) United States
(12) Patent Application Publication
(10) Pub. No.: US 2023/0356618 A1
(43) Pub. Date: Nov. 9, 2023

(54) METHODS AND APPARATUS FOR PROVIDING CHARGING-RELATED BENEFITS TO AN ELECTRIC VEHICLE USER

(71) Applicant: Enphase Energy, Inc., Petaluma, CA (US)

(72) Inventor: Raghuveer R. BELUR, Los Altos Hills, CA (US)

(21) Appl. No.: 18/142,249

(22) Filed: May 2, 2023

Related U.S. Application Data
(60) Provisional application No. 63/337,862, filed on May 3, 2022.

(51) Int. Cl. B60L 53/68; B60L 53/51; H02J 7/35; B60L 53/66

(52) U.S. Cl. CPC B60L 53/68; B60L 53/51; H02J 7/35; B60L 53/66

(57) ABSTRACT

An electric vehicle supply equipment system for electric vehicle charging is provided and comprises an electric vehicle supply equipment that is connectable to a distributed energy resource for charging/discharging a battery of an electric vehicle and a controller in operative communication with at least one of a communication network, an electronic device of the electric vehicle, or a distributed energy resource controller for transmitting and receiving electric vehicle supply equipment information associated with a manufacturer of at least one of the electric vehicle supply equipment or the electric vehicle to provide charging/discharging of the battery at a public charging station associated with the manufacturer.

### CROSS-REFERENCE TO RELATED APPLICATIONS

This application claims the benefit of and priority to U.S. Provisional Patent Application Ser. No. 63/337,862, filed on May 3, 2022, the entire contents of which is incorporated herein by reference.

### BACKGROUND

### Field of the Disclosure

Embodiments of the present disclosure relate generally to methods and apparatus configured for use with electric vehicles, and, for example, to methods and apparatus for providing charging-related benefits to an electric vehicle user.

### Description of the Related Art

Electric vehicle (EV) owners generally have two options for charging, e.g., at privately-owned charging stations (typically at a home) or at public charging stations. The two charging sources are unique and act as independent charging networks, yet the providers of private charging stations overlap with public stations and/or have overlapping business relationships with public stations. Public charging stations may require payment or other consideration and currently offer no benefit or advantage to an EV owner that has purchased a private charging station, e.g., a station that is the same brand or supplied by the same company.

Therefore, a need exists for improved methods and apparatus for providing charging-related benefits to an electric vehicle user.

### SUMMARY

Methods and apparatus configured for providing charging-related benefits to an electric vehicle user provided herein. For example, in some embodiments, an electric vehicle supply equipment system for electric vehicle charging comprises an electric vehicle supply equipment that is connectable to a distributed energy resource for charging/discharging a battery of an electric vehicle; and a controller in operative communication with at least one of a communication network, an electronic device of the electric vehicle, or a distributed energy resource controller for transmitting and receiving electric vehicle supply equipment information associated with a manufacturer of at least one of the electric vehicle supply equipment or the electric vehicle to provide charging/discharging of the battery at a public charging station associated with the manufacturer.

In accordance with some aspects of the disclosure, a system for electric vehicle charging comprises a solar array comprising a distributed energy resource; a distributed energy resource controller operably connected to the distributed energy resource; and an electric vehicle supply equipment system, comprising: an electric vehicle supply equipment that is connectable to the distributed energy resource for charging/discharging a battery of an electric vehicle; and a controller in operative communication with at least one of a communication network, an electronic device of the electric vehicle, or the distributed energy resource controller for transmitting and receiving electric vehicle supply equipment information associated with a manufacturer of at least one of the electric vehicle supply equipment or the electric vehicle to provide charging/discharging of the battery at a public charging station associated with the manufacturer.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIG. 2 is a diagram of an EVSE system that is configured to connect to the energy management system of FIG. 1, in accordance with one or more embodiments of the present disclosure; and

FIG. 3 is a block diagram of an electronic device configured for use with the energy management system and the EVSE system of FIG. 1 and FIG. 2, respectively, in accordance with at least one embodiment of the present disclosure.

### DETAILED DESCRIPTION

Embodiments of the present disclosure generally relate to methods and apparatus for providing charging-related benefits to an electric vehicle user. For example, an electric vehicle supply equipment system for electric vehicle battery charging can comprise electric vehicle supply equipment that is connectable to a distributed energy resource for charging/discharging a battery of an electric vehicle. In at least some embodiments, a controller can be in operative communication with at least one of a communication network, an electronic device of the electric vehicle, or a distributed energy resource controller for transmitting and receiving electric vehicle supply equipment information associated with a manufacturer of at least one of the electric vehicle supply equipment or the electric vehicle to provide charging/discharging of the battery at a public charging station associated with the manufacturer.

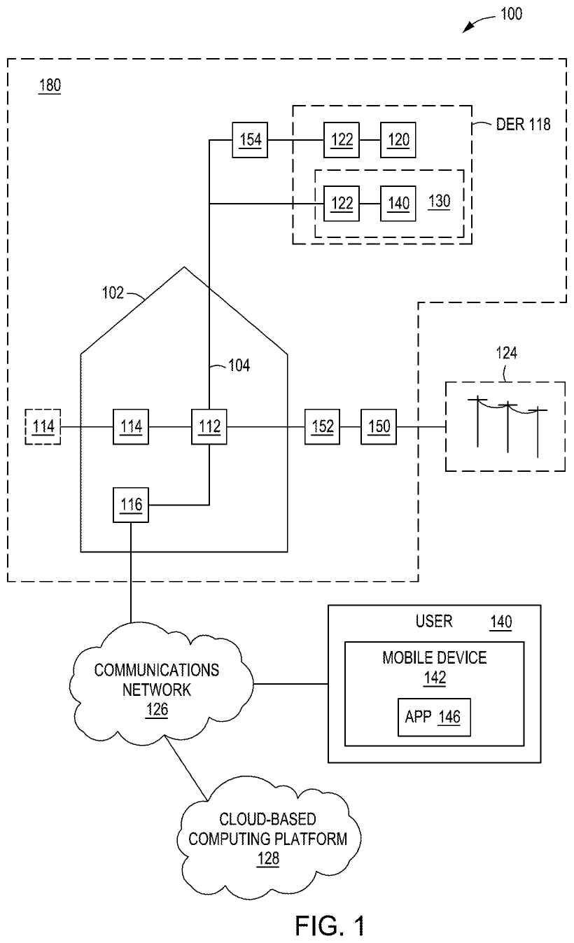

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads and/or energy storage devices 114 (e.g., appliances, electric hot water heaters, thermostats/detectors, boilers, electric vehicle supply equipment (EVSE), water pumps, and the like), which can be located within or outside the structure 102, and a DER controller 116, each coupled to a load center 112. Although the energy storage devices 114, the DER controller 116, and the load center 112 are depicted as being located within the structure 102, one or more of the energy storage devices 114, the DER controller 116, and the load center 112 may be located external to the structure 102.

The load center 112 is coupled to the DER 118 by an AC bus 104 and is further coupled, via a meter 152 and a MID 150 (microgrid interconnect device), to a grid 124 (e.g., a commercial/utility power grid). The structure 102, the energy storage devices 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a battery (e.g., the batteries 141) may be referred to as an AC battery 130.

The power conditioners 122 invert the generated DC power from the plurality of RESs 120 and/or the batteries 141 to AC power that is grid-compliant and couple the generated AC power to the grid 124 via the load center 112. The generated AC power may be additionally or alternatively coupled via the load center 112 to the one or more loads (e.g., EV, EVSE) and/or the energy storage devices 114. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications (e.g., a grid connectivity control application (e.g., an application 146)) installed thereon for controlling the connectivity with the grid 124 as described herein. The application 146 may run on commercially available operating systems, such as 10S, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

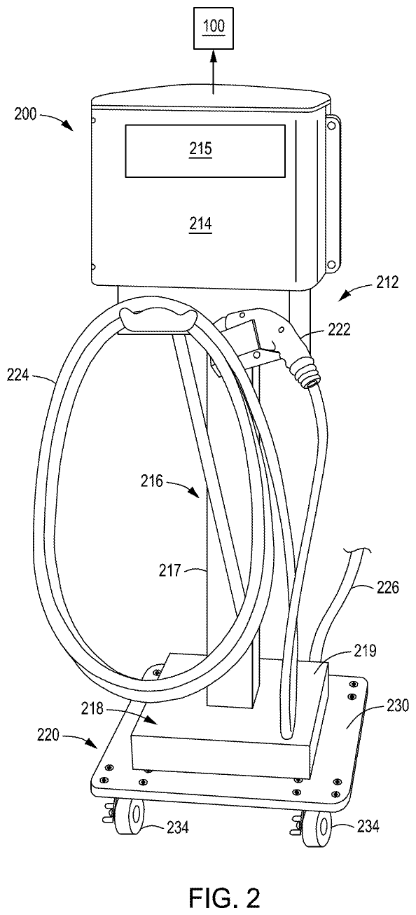

FIG. 2 is a diagram of an EVSE system (a system 200), in accordance with one or more embodiments of the present disclosure. As shown in FIG. 2, the system 200 is configured to connect to the system 100 (e.g., via one or more of the previously described communication devices) and comprises an electric vehicle supply equipment 212, a housing enclosure 214, a pedestal 216 having a base 218, and a transport module 220 coupled to the base 218. The electric vehicle supply equipment 212 can include an electric vehicle connector 222, which can comprise a cord 224, configured for connection to an electric vehicle inlet (not shown). The electric vehicle supply equipment 212 can include a service entrance cable 226 configured to connect, for example, to the load center 112 wiring to deliver energy to the electric vehicle connector 222. The electric vehicle supply equipment 212 can include a controller 215 (e.g., similar to the DER controller 116) which can be housed in the housing enclosure 214. The electric vehicle supply equipment 212 can also include ungrounded, grounded, and equipment grounding conductors, attachment plugs, and other fittings, devices, power outlets, or apparatuses necessary to deliver energy from the premises wiring (not shown) to an EV (not shown), all or a portion of which may be enclosed within housing enclosure 214. The pedestal 216 is coupled to and supports the housing enclosure 214 and may include a hollow tubular portion 217 and a base 218. The base 218 may include a base cover 219 and a base plate (not shown) configured to engage and be supported on a top surface of the transport module 220. The transport module 220 comprises a platform 230 that is configured to support the base 218, and wheels 234 are provided on the platform 230 to facilitate moving the system 200 when not connected to the system 100.

The electric vehicle supply equipment 212 (including electric vehicle connector 222, cord 224, and service entrance cable 226), the housing enclosure 214, and the pedestal 216 (including hollow tubular portion 217 and base 218), may be a commercially available electric vehicle charge station such as, for example, but not limited to, a CS Series Public EVSE provided by ClipperCreek, Inc. of Auburn, Calif. The system 200 allows a user (e.g., owner) of an EV to take advantage of certain charging-related benefits, e.g., while not at home. For example, a manufacturer of a charging station can manufacture and/or have relationships with both private and public charging stations. The manufacture may wish to incentivize consumers to buy the manufacturer's private station by offering benefits for public charging stations, or other benefits. If, for example, an EV is associated with the purchase of a private charging station (e.g., the system 200), when that EV goes to a public charging station that is provided by the same manufacturer (or is otherwise affiliated with that manufacturer), the public charging station may be configured to provide charging or one or more other services, e.g., based on control information. For example, the control information can relate to a service level agreement between an owner of the electric vehicle supply equipment or the electric vehicle and the manufacturer private of the charging station and the public charging station. The control information enables at least one functionality associated with charging/discharging of the battery of an EV at the public charging station associated by the manufacturer. For example, in at least some embodiments, service level agreement terms may enable the public charging station to provide free charging, reduced cost of charging, a maximum amount of power, a maximum amount of energy within a set period of time, etc. In at least some embodiments, the service level agreement terms may be stored in the controller 215, and when the system 200 is connected to the system 100, the controller 215 can transmit the service level agreement terms to the DER controller 116 and/or a controller of an EV for storage and future use thereof. Alternatively or additionally, the service level agreement terms can be accessed via a cloud-based computing platform (e.g., the cloud-based computing platform 128) and downloaded to the DER controller 116 and/or a controller of an EV for storage and future use thereof. The service level agreement terms may be dynamically adjustable over-the-air and also may be based on time, availability, prior use, or other factors.

Additionally, because the EV can be associated with a purchase of a private charging station, additional benefits can also be provided while the EV is away from home. For example, in at least some embodiments, the at least one functionality enables an owner of the EV with intelligent routing (via an in-electric vehicle navigation system, a portable navigation system, or a smartphone-based application) to public charging stations based on real-time information about the EV (e.g., location, remaining mileage on battery, direction, ultimate or final destination, etc.). In such embodiments, the controller of the EV can be in operative communication with the in-EV navigation system, the portable navigation system, or the smartphone-based application. For example, the intelligent routing can be based on a most appropriate charging station associated with that manufacturer. In at least some embodiments the criterion in considering a most appropriate charging station may be based on an ability of the EV owner to discharge energy from the EV through a bidirectional charging station. In such embodiments, an algorithm, under control of the controller 215, may be provided in the system 200, which allows a user to specify a minimum state of charge to maintain (or one or more other criterion) and which may associate the available charging stations, their respective consideration for discharging energy, the anticipated discharge power, time of day, etc. with the EV.

In at least some embodiments, the at least one functionality enables reservation capabilities for the EV. For example, the at least one functionality enables a lock-out feature at a public charging station such that after a certain time the public charging station can lock-out other EV users from charging an EV for a predetermined amount of time, so that public charging is available for the EV owner when needed (e.g., as estimated by the navigation feature). In such embodiments, one or more of the controllers described herein (e.g., the DER controller 116, the controller 215, and/or the controller of the EV) can transmit a reservation request directly to an appropriate public charging station, via, for example, the communication network, the cloud-based computing platform, or other suitable transmission/communication apparatus.

In at least some embodiments, the EV can be geotagged in one of various commonly-known ways, such as a GPS tracker or other suitable tracking device. Alternatively or additionally, an authentication procedure may be used for verifying that an owner and an EV are both present at the public station, e.g., application software that requires owner identity verification. For example, the application software can perform identity verification through a smartphone (or other suitable verification device) to take a picture of a license plate for OCR recognition, which can be compared with the EV registered to the private charging station.

In at least some embodiments, performing identity verification can also be used to prevent fraud, e.g., an owner from sharing charging benefits with others, an owner selling the EV to another person without transferring ownership of the in-home charging station, or from an owner charging unauthorized EVs using, for example, simply an ID or a phone.

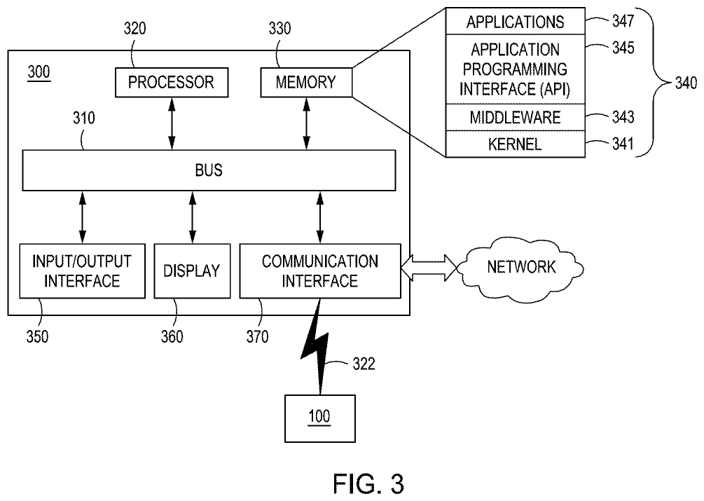

FIG. 3 is a block diagram of an electronic device configured for use with the energy management system and the EVSE system of FIG. 1 and FIG. 2, respectively, in accordance with at least one embodiment of the present disclosure. One or more of the components of electronic device 300 may also be a component of the devices of the system 100 (e.g., the storage system 108, the smart switch 110, the DER controller 116, the combiner 107, the one or more PVs 106 (e.g., solar panels), and the load center 112), a component of an EV, and a component of the system 200 (e.g., the controller 215).

The electronic device 300 includes a bus 310, a processor 320 (or controller), a memory 330 (or storage, e.g., non-transitory computer readable storage medium), an input/output interface 350, a display 360, and a communication interface 370. At least one of the above-described components may be omitted from the electronic device 300 or another component may be further included in the electronic device 300.

The bus 310 may be a circuit connecting the above-described components (e.g., the processor 320, the memory 330, the input/output interface 350, the display 360, and the communication interface 370) and transmitting communications (e.g., control messages and/or data) between the above-described components.

The processor 320 may include one or more of a central processing unit (CPU), an application processor (AP), and a communication processor (CP). The processor 320 can control at least one of the other components of the electronic device 300 and/or processing data or operations related to communication.

The memory 330 may include volatile memory and/or non-volatile memory. The memory 330 can store data or commands/instructions related to at least one of the other components of the electronic device 300. The memory 330 can store software and/or a program module 340 (e.g., instructions for performing one or more of the operations/functions of the system 100, the system 200, and/or the EV described herein). For example, the program module 340 may include a kernel 341, middleware 343, an API 345, application 347 (e.g., software-based application for performing one or more of the operations/functions of the system 100, the system 200, and/or the EV described herein). The kernel 341, the middleware 343 or at least part of the API 345 may be called an operating system.

The kernel 341 can control or managing system resources (e.g., the bus 310, the processor 320, the memory 330, etc.) used to execute operations or functions of other programs (e.g., the middleware 343, the API 345, and the applications 347). The kernel 341 provides an interface capable of allowing the middleware 343, the API 345, and the applications 347 to access and control/manage the individual components of the electronic device 300.

The middleware 343 may be an interface between the API 345 or the applications 347 and the kernel 341 so that the API 345 or the applications 347 can communicate with the kernel 341 and exchange data therewith. The middleware 343 is capable of processing one or more task requests received from the applications 347. The middleware 343 can assign a priority for use of system resources of the electronic device 300 (e.g., the bus 310, the processor 320, the memory 330, etc.) to the application 347. The middleware 343 processes one or more task requests according to a priority assigned to at least one application program, thereby performing scheduling or load balancing for the task requests.

The API 345 may be an interface that is configured to allow the applications 347 to control functions provided by the kernel 341 or the middleware 343. The API 345 may include at least one interface or function (e.g., instructions) for file control, window control, image process, text control, or the like. For example, during the methods described herein, the API 345 allows the applications 347 to display one or more user interfaces that allow a user to navigate, for example, through one or more screens to enter information associated with the methods.

The input/output interface 350 is capable of transferring instructions or data received from a user or external devices to one or more components of an electronic device (e.g., one or more of the components of the system 100). The input/output interface 350 is capable of outputting instructions or data, received from one or more components of the electronic device 300, to the user or external devices. The input/output interface 350 can be configured to create one or more GUIs for receiving a user input or an input from an electronic device (e.g., a user smart phone). In at least some embodiments, the input can be a request for enabling one or more of the above-described functions.

The display 360 may include a liquid crystal display (LCD), a flexible display, a transparent display, a light emitting diode (LED) display, an organic LED (OLED) display, micro-electro-mechanical systems (MEMS) display, an electronic paper display, etc. The display 360 can display various types of content (e.g., texts, images, videos, icons, symbols, etc.). The display 360 may also be implemented with a touch screen. The display 360 can receive touches, gestures, proximity inputs or hovering inputs, via a stylus pen, or a user's body. Accordingly, the display 350 can be used to receive a user input on one or more GUIs.

The communication interface 370 can establish communication between the electronic device 300 and an external device (e.g., mobile device 142, the DER controller 116, etc. of the system 100, the controller 215, and/or the controller of the EV) connected to a network via wired or wireless communication.

Wireless communication may employ, as cellular communication protocol, at least one of long-term evolution (LTE), LTE advance (LTE-A), code division multiple access (CDMA), wideband CDMA (WCDMA), universal mobile telecommunications system (UMTS), wireless broadband (WiBro), and global system for mobile communication (GSM). Wireless communication may also include short-wireless communication 322. Short-wireless communication 322 may include at least one of wireless fidelity (Wi-Fi), BT, BLE, Zigbee, near field communication (NFC), magnetic secure transmission (MST), etc. Wired communication may include at least one of universal serial bus (USB), high definition multimedia interface (HDMI), recommended standard, and plain old telephone service (POTS). The network may include at least one of a telecommunications network, e.g., a computer network (e.g., local area network (LAN) or WAN), the Internet, and a telephone network.

The inventive concepts described can also be expanded to other relational assets, not just limited to public charging stations that are associated with a purchased charging station. For example, a manufacturer of other products or services may wish to provide a benefit/incentive to a user of a corresponding product or service that can be associated a user's EV in such a way that they can take advantage of the one or more benefits/incentives described above.

While the foregoing is directed to embodiments of the present disclosure, other and further embodiments of the disclosure may be devised without departing from the basic scope thereof, and the scope thereof is determined by the claims that follow.

What is claimed is:

1. An electric vehicle supply equipment system for electric vehicle battery charging, comprising:
an electric vehicle supply equipment that is connectable to a distributed energy resource for charging/discharging a battery of an electric vehicle; and
a controller in operative communication with at least one of a communication network, an electronic device of the electric vehicle, or a distributed energy resource controller and configured to transmit and receive electric vehicle supply equipment information associated with a manufacturer of at least one of the electric vehicle supply equipment or the electric vehicle to provide charging/discharging of the battery at a public charging station associated with the manufacturer.

2. The electric vehicle supply equipment system of claim 1, wherein the controller is further configured to store control information relating to a service level agreement between an owner of the electric vehicle supply equipment or the electric vehicle and the manufacturer, and
wherein the control information enables at least one functionality associated with charging/discharging of the battery at the public charging station associated by the manufacturer.

3. The electric vehicle supply equipment system of claim 2, wherein charging/discharging of the battery at the public charging station is based on at least one of free charging, reduced cost of charging, maximum amount of power, or maximum amount of energy within a set period of time.

4. The electric vehicle supply equipment system of claim 2, wherein the control information is dynamically adjustable over-the-air, and
wherein the control information is based on at least one of time, availability, or prior use.

5. The electric vehicle supply equipment system of claim 2, wherein the at least one functionality enables intelligent routing via at least one of an in-electric vehicle navigation system, a portable navigation system, or a smartphone-based application to the public charging station, and
wherein the at least one of the in-electric vehicle navigation system, the portable navigation system, or the smartphone-based application are configured to enable reservation capabilities that allow a lock-out feature at the public charging station such that after a certain time the public charging station can lock-out other electric vehicles from charging for a predetermined amount of time.

6. The electric vehicle supply equipment system of claim 5, wherein the intelligent routing is based on at least one of a most appropriate charging station associated with the manufacturer or real-time information about the electric vehicle,
wherein the most appropriate charging station associated with the manufacturer is based on an ability of the owner of the electric vehicle to discharge energy from the electric vehicle through a bidirectional charging station, and
wherein the real-time information comprises at least one of a location of the electric vehicle, a remaining mileage on the battery of the electric vehicle, a direction of where the electric vehicle is traveling, or a final destination of the electric vehicle.

7. The electric vehicle supply equipment system of claim 1, wherein the controller is further configured to transmit a reservation request directly to the public charging station via the communication network.

8. The electric vehicle supply equipment system of claim 1, wherein the controller is further configured to at least one of allow a user to specify a minimum state of charge to maintain or associate available charging stations, their respective consideration for discharging energy, an anticipated discharge power, or a time of day with the electric vehicle.

9. A system for electric vehicle battery charging, comprising:
a solar array comprising a distributed energy resource;
a distributed energy resource controller operably connected to the distributed energy resource; and
an electric vehicle supply equipment system, comprising:
an electric vehicle supply equipment that is connectable to the distributed energy resource for charging/discharging a battery of an electric vehicle; and
a controller in operative communication with at least one of a communication network, an electronic device of the electric vehicle, or the distributed energy resource controller for transmitting and receiving electric vehicle supply equipment information associated with a manufacturer of at least one of the electric vehicle supply equipment or the electric vehicle to provide charging/discharging of the battery at a public charging station associated with the manufacturer.

10. The system of claim 9, wherein the controller is further configured to store control information relating to a service level agreement between an owner of the electric vehicle supply equipment or the electric vehicle and the manufacturer, and
wherein the control information enables at least one functionality associated with charging/discharging of the battery at the public charging station associated by the manufacturer.

11. The system of claim 10, wherein charging/discharging of the battery at the public charging station is based on at least one of free charging, reduced cost of charging, maximum amount of power, or maximum amount of energy within a set period of time.

12. The system of claim 10, wherein the control information is dynamically adjustable over-the-air, and
wherein the control information is based on at least one of time, availability, or prior use.

13. The system of claim 10, wherein the at least one functionality enables intelligent routing via at least one of an in-electric vehicle navigation system, a portable navigation system, or a smartphone-based application to the public charging station, and
wherein the at least one of the in-electric vehicle navigation system, the portable navigation system, or the smartphone-based application are configured to enable reservation capabilities that allow a lock-out feature at the public charging station such that after a certain time the public charging station can lock-out other electric vehicles from charging for a predetermined amount of time.

14. The system of claim 13, wherein the intelligent routing is based on at least one of a most appropriate charging station associated with the manufacturer or real-time information about the electric vehicle,
wherein the most appropriate charging station associated with the manufacturer is based on an ability of the owner of the electric vehicle to discharge energy from the electric vehicle through a bidirectional charging station, and
wherein the real-time information comprises at least one of a location of the electric vehicle, a remaining mileage on the battery of the electric vehicle, a direction of where the electric vehicle is traveling, or a final destination of the electric vehicle.

15. The system of claim 10, wherein the controller is further configured to transmit a reservation request directly to the public charging station via the communication network.

16. The system of claim 10, wherein the controller is further configured to at least one of allow a user to specify a minimum state of charge to maintain or associate available charging stations, their respective consideration for discharging energy, an anticipated discharge power, or a time of day with the electric vehicle.
